(19) United States
(12) Patent Application Publication
(10) Pub. No.: US 2022/0382742 A1
(43) Pub. Date: Dec. 1, 2022

(54) ENSURING HIGH AVAILABLITY OF REPLICATED DATABASE MANAGEMENT SYSTEMS DURING UPGRADES

(71) Applicant: salesforce.com, inc., San Francisco, CA (US)

(72) Inventors: Brett Michael Procek, Berkeley, CA (US); Bharath Ram Manoharan, Pleasanton, CA (US); Peter Thang Doan, San Francisco, CA (US); Shivakarthik Subramanyam, Dublin, CA (US); Zhuo Yao Chen, Needham, MA (US); Paul Sydell, San Rafael, CA (US); Swadesh Raj Bhattarai, Fremont, CA (US)

(21) Appl. No.: 17/334,570

(22) Filed: May 28, 2021

(51) Int. Cl. G06F 16/23; G06F 16/27; G06F 16/21; G06F 9/48; G06F 11/14

(52) U.S. Cl. CPC G06F 16/2379; G06F 16/278; G06F 16/21; G06F 9/4881; G06F 11/142

(57) ABSTRACT

An online system, such as a multi-tenant system ensures high availability of systems, for example, database management systems. The online system replicates the databases across multiple datacenters including: (1) a master node that receives read and write requests (2) a read-replica that receives only read requests and (3) a spare node that does not receive requests but acts as standby for high availability. One or more application servers may send read and write requests to the databases. The system performs a sweep of upgrades of the database nodes and also performs traffic quiescing of the requests received from the application servers to redirect the traffic across the database nodes as the upgrade sweep is orchestrated. The sweep of upgrades ensures that the availability of the database management system to the end users is maximized during the upgrade process.

### BACKGROUND

### Field of Art

This disclosure relates in general to database management systems and in particular to ensuring high availability during upgrades of replicated database management systems.

### Description of the Related Art

Organizations are increasingly relying on cloud platforms such as AWS (AMAZON WEB SERVICES), GOOGLE cloud platform, MICROSOFT AZURE, and so on for their infrastructure needs. Cloud platforms provide servers, storage, databases, networking, software, and other computing resources over the internet to organizations. Organizations are shifting their information technology (IT) infrastructure to cloud platforms to take advantage of the scalability and elasticity of computing resources provided by the cloud platforms. An important component of the IT infrastructure being moved to cloud platforms by organizations includes databases of the organization. Online system such as multi-tenant systems store data of multiple enterprises in a database or in multiple databases. Each database of a multi-tenant system may store data of multiple enterprises that act as tenants of the multi-tenant system.

When such online systems receive a new release or version of the database management system, they upgrade instances of database management system deployed in the cloud platform. Conventional techniques for upgrading the database systems requires the database systems to be shut down during the upgrade process. This results in disruption of service provided by the database system. Online systems such as multi-tenant systems receive heavy traffic of requests to such database systems. Since, a database instance of a multi-tenant system is typically used by multiple tenants, each tenant may receive traffic of requests from multiple users. Shutting down a database system of such a system may disrupt services for a large number of users and may affect several enterprises.

### BRIEF DESCRIPTION OF DRAWINGS

FIG. 1 is a block diagram of a system environment 100 illustrating an online system that uses a database management system deployed on a cloud platform, according to one embodiment.

FIG. 2 is a block diagram illustrating architecture of an online system configured to upgrade a replicated database management system, according to one embodiment.

FIG. 3 is a block diagram illustrating architecture of a database virtual machine instance configured to run on a cloud platform, according to one embodiment.

FIG. 4 is a block diagram illustrating deployment of a database virtual machine instance on a cloud platform, according to an embodiment.

FIG. 5 is an architecture of a replicated database management system, according to one embodiment.

FIG. 6 is a flow chart illustrating the process for performing an upgrade of a replicated database management system, according to one embodiment.

FIG. 7 is a block diagram illustrating the process for performing an upgrade of a replicated database management system, according to one embodiment.

FIG. 8 is a flow chart illustrating the process for upgrading a specific node in a replicated database management system, according to one embodiment.

FIG. 9 is a block diagram illustrating a functional view of a typical computer system for use in the environment of FIG. 1 according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

The figures use like reference numerals to identify like elements. A letter after a reference numeral, such as “115a,” indicates that the text refers specifically to the element having that particular reference numeral. A reference numeral in the text without a following letter, such as “115,” refers to any or all of the elements in the figures bearing that reference numeral.

### DETAILED DESCRIPTION

An online system, such as a multi-tenant system ensures high availability of systems, for example, database management systems. Conventional techniques for upgrading a database management system require shutting down the database management system. As a result, the database management system is not available to applications and end users during an upgrade. To ensure high availability of the database management system, the online system replicates the databases across multiple datacenters. For example, the replicas of the databases are located in datacenters that are physically separated by at least a threshold distance to ensure that a disaster that affects one datacenter does not affect the remaining datacenters. A replicated database management system includes a plurality of nodes, each node comprising a database management system that stores a replica of the data. One or more application servers may send requests to the databases. The request can be processed by any one of the nodes of the replicated database management system.

The online system according to an embodiment, upgrades such a replicated database system while ensuring high availability. In an embodiment, the online system uses three nodes: (1) a master node that receives read and write requests (2) read-replica that receives only read requests and (3) spare node that does not receive requests but acts as standby for high availability. The system performs a sweep of upgrades in a specific order of the database nodes and also performs traffic quiescing of the application servers to ensure the traffic is redirected across the database nodes as the upgrade sweep is orchestrated. The sweep of upgrades ensures that the availability of the database management system to the end users is maximized during the upgrade process.

### System Environment

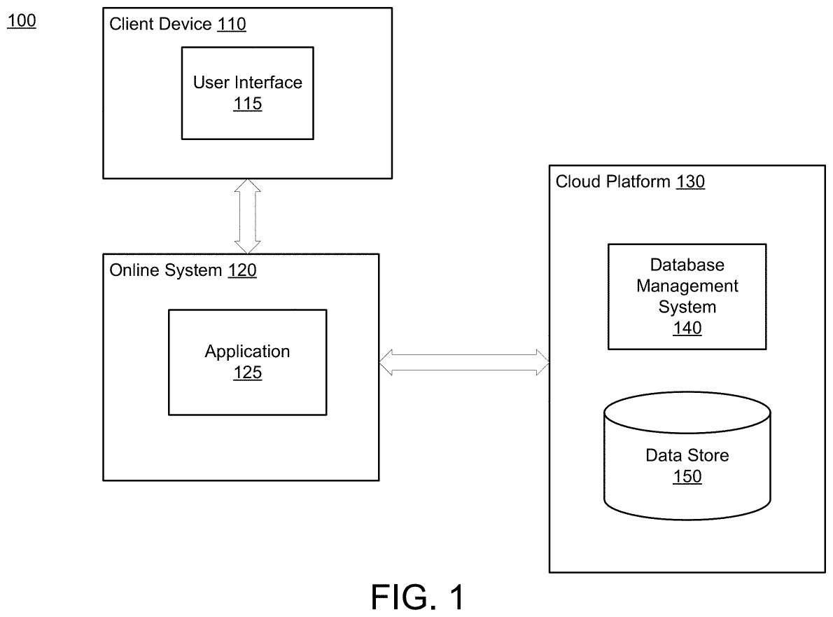

FIG. 1 is a block diagram of a system environment illustrating an online system that uses a database management system deployed on a cloud platform, according to one embodiment. The system environment 100 comprises an online system 120, a cloud platform 130, and one or more client devices 110. A cloud platform may also be referred to herein as a cloud computing platform. In other embodiments, the system environment 100 may include other more or fewer components, for example, there may be multiple cloud platforms 130 used by the online system 120.

The cloud platform 130 includes the database management system 140 and data store 150. The online system 120 executes an application 125 that uses the database management system 140 deployed on the cloud platform 130. The database management system 140 includes instructions for processing data stored in data store 150. The database management system 140 may be a relational database management system such as ORACLE, DB2, MYSQL, PostgreSQL, and so on but is not limited to relational database management systems. For example, the database management system may be a NOSQL database that stores key-value pairs or a column-oriented database. The database management system may include instructions for various components, for example, a query processor, a query parser, query planner, a query compiler, a query optimizer, an execution engine and so on. The database management system provides instructions for upgrading the database management system in place.

The replicated DBMS includes a plurality of nodes. The online system may change the role that a node plays within the replicated DBMS. For example, a node can be a master node, a read-replica node, or a spare node. The system may convert a spare node to a read-replica node, a read-replica node to a master node, a spare node to a master node, a master node to a spare node, and so on. In an embodiment, the system converts each node to a spare node before upgrading the node. Accordingly, the system converts one or the remaining two nodes to a master node and the other one of the remaining two nodes to a read-replica node. The system directs all the write request to the master node and distributes the read requests across the master node and the read-replica node. Once the spare node is upgraded, the system repeats this process to upgrade another node of the replicated database management system.

The cloud platform 130 uses an immutable infrastructure approach. Accordingly, software installed on the cloud platform 130 cannot be upgraded in place. For example, assume that the database management system 140 runs version V1 of software and needs to be upgraded to version V2. The immutable infrastructure approach requires that the executables of the database management system 140 version V1 installed on the cloud platform 130 are not modified to upgrade the software to version V2. Instead, a new instance of the management system 140 is installed for version V2 and online traffic moved from the old instance running version V1 to the new instance running version V2. Conventional database management systems use a mutable infrastructure approach and provide instructions that require the software to be upgraded in place. For example, one or more executable files storing instructions for components of the database management system are replaced with modified executable instructions. Accordingly, conventional database management systems provide instructions to modify the executables of the instance running version V1 so that the instance is modified to run version V2.

The application 125 may be a web application that receives requests from client devices and may execute database queries using database management system that may be running on the cloud platform. The application 125 configures a user interface 115 for display on a client device 110. The user interface may be displayed by an application running on the client device 110, for example, a browser application. The user interface 115 may allow a user to interact with the online system 120 to access data stored in the data store 150 or update the data stored in the data store 150. For example, the user may execute an application in connection with an interaction with one or more other users to complete a transaction.

In some embodiments, the online system 120 is a multi-tenant system. A tenant of the multi-tenant system may be an enterprise or an organization. A tenant may represent a customer of the multi-tenant system that has multiple users that interact with the multi-tenant system via client devices 110. A multi-tenant system stores data for multiple tenants in the same physical database. However, the database is configured so that data of one tenant is kept logically separate from that of other tenants so that one tenant does not have access to another tenant's data, unless such data is expressly shared. It is transparent to tenants that their data may be stored in a table that is shared with data of other customers. A database table may store rows for a plurality of tenants. Accordingly, in a multi-tenant system, various elements of hardware and software of the system may be shared by one or more tenants. For example, the multi-tenant system may execute an application server that simultaneously processes requests for a number of tenants. However, the multi-tenant system enforces tenant-level data isolation to ensure that jobs of one tenant do not access data of other tenants.

The database management system 140 manages data that is processed by the online system 120. In embodiments where the online system is a multi-tenant system, the database management system 140 stores data for various tenants of the multi-tenant system. The database management system 140 may store data for different tenants in separate physical structures, for example, separate database tables or separate databases. Alternatively, the database management system 140 may store data of multiple tenants in a shared structure. For example, user accounts for all tenants may share the same database table. The multi-tenant system stores additional information to logically separate data of different tenants. Accordingly, the multi-tenant system implements a multi-tenant schema configured to store data for multiple tenants in a shared structure while maintaining data isolation. According to one embodiment, the online system 120 is configured to provide webpages, forms, applications, data and media content to client devices 110 to support the access by client devices 110 as tenants of online system 120. As such, online system 120 provides security mechanisms to keep each tenant's data separate unless the data is shared.

In one embodiment, the online system 120 is a multi-tenant system that implements a web-based customer relationship management (CRM) system and an application server provides users access to applications configured to implement and execute CRM software applications. The multi-tenant schema may include structures such as database tables to manage the data for CRM software. For example, the online system 120 may provide tenant access to multiple hosted (standard and custom) applications, including a CRM application.

Each component shown in FIG. 1 represents one or more computing devices. A computing device can be a conventional computer system executing, for example, a Microsoft™ Windows™-compatible operating system (OS), Apple™ OS X, and/or a Linux distribution. A computing device can also be a client device having computer functionality, such as a personal digital assistant (PDA), mobile telephone, video game system, etc. Each computing device stores software modules storing instructions.

The interactions between the client devices, the online system, and the cloud platform are typically performed via a network, for example, via the Internet. In one embodiment, the network uses standard communications technologies and/or protocols. In another embodiment, the entities can use custom and/or dedicated data communications technologies instead of, or in addition to, the ones described above. The techniques disclosed herein can be used with any type of communication technology, so long as the communication technology supports receiving by the online system of web requests from a sender, for example, a client device and transmitting of results obtained by processing the web request to the sender.

Although the system architecture and several processes described herein are illustrated using a multi-tenant system, the techniques disclosed are not limited to multi-tenant systems but can be executed by any online system, for example, an online system used by a single enterprise.

### System Architecture

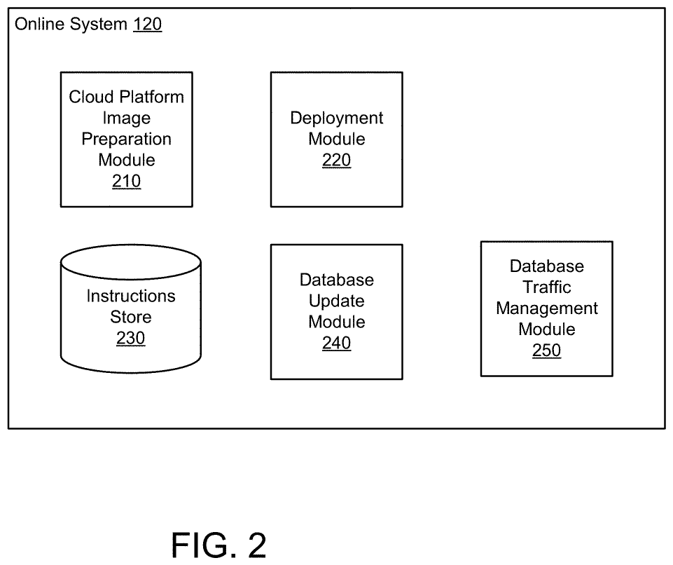

FIG. 2 is a block diagram illustrating architecture of an online system configured to upgrade a database management system deployed on a cloud platform, according to one embodiment. The online system 120 includes a cloud platform image preparation module 210, a deployment module 220, an instructions store 230, a database upgrade module 240, and a database traffic management module 250. Other embodiments can have different and/or other components than the ones described here, and the functionalities can be distributed among the components in a different manner. The modules described may be stored in a system other than the online system 120. For example, some or all of the instructions of the deployment module 220 may be stored and executed on the cloud platform 130.

The instructions store 230 stores instructions of the database management system. These include instructions of the relevant version of the operating system as well as application level instructions of the database management system, for example, instructions for processing data stored in a database. The instructions of the database management system may be stored as libraries of executable instructions, for example, binary files. An upgrade may update one or more libraries storing instructions of the database, for example, to add new features or to fix certain known defects in the instructions.

The cloud platform image preparation module 210 collects all instructions relevant for deploying a version of a database management system on the cloud platform and prepares a cloud platform image. Examples of cloud platform images include AMI (AMAZON machine image) or a VM image of Azure or an image configured for any other cloud platform, for example, GCP (GOOGLE CLOUD PLATFORM). The cloud platform image is provided to the cloud platform for deploying the database management system or for upgrading the database management system to a new version.

The deployment module 220 provides instructions to the cloud platform for deploying and upgrading the database management system. The deployment module 220 may execute instructions on the cloud platform for performing upgrades to the database management system. In an embodiment, the deployment module 220 specifies a pipeline of various stages that perform various tasks related to upgrading the database management system in the cloud platform.

The database upgrade module 240 manages the process of upgrading a replicated database management system. The database upgrade module 240 may send instructions to various modules for executing the various steps of the upgrade process. In an embodiment, the database upgrade module 240 generates an orchestration pipeline comprising a sequence of stages, each stage including a set of instructions to perform an operation (or a step) during the upgrade process. The database upgrade module 240 sends the orchestration pipeline for execution to an orchestration engine used for deploying software on the cloud platform, for example, SPINNAKER. The database upgrade module 240 may invoke various tools, for example, continuous delivery platforms such as SPINNAKER for overall orchestration, tools such as TERRAFORM for resource provisioning, building, changing, and versioning database infrastructure, and proprietary tools or scripts for configuring the database.

The database traffic management module 250 manages traffic (or communications) to the various nodes of the replicated DBMS. There may be a plurality of application servers that send requests to a replicated DBMS. The database traffic management module 250 coordinates across the various application servers to ensure that the read/write requests are directed to the correct node of the replicated DBMS. In an embodiment, the database traffic management module 250 sends a request to each of the plurality of application servers to quiesce requests and waits for each of the plurality of application servers to send an acknowledgement message indicating a completion of quiescing of requests.

The database traffic management module 250 tracks the roles that the various nodes currently have and directs the requests accordingly. The database traffic management module 250 directs all write requests to the master node. The database traffic management module 250 distributes the read requests across the master node and the read-replica node. In an embodiment, there is an additional overhead of processing a request using the read-replica node compared to the master node. Accordingly, the database traffic management module 250 sends a smaller fraction of read requests to the read-replica node compared to the master node. In an embodiment, the database traffic management module 250 moves the role of master node from a database D1 to D2 by ensuring that all write requests to the node D1 are quiesced before the write requests are directed to the node D2. This ensures that only one node is processing the write requests at a time.

### Database Virtual Machine

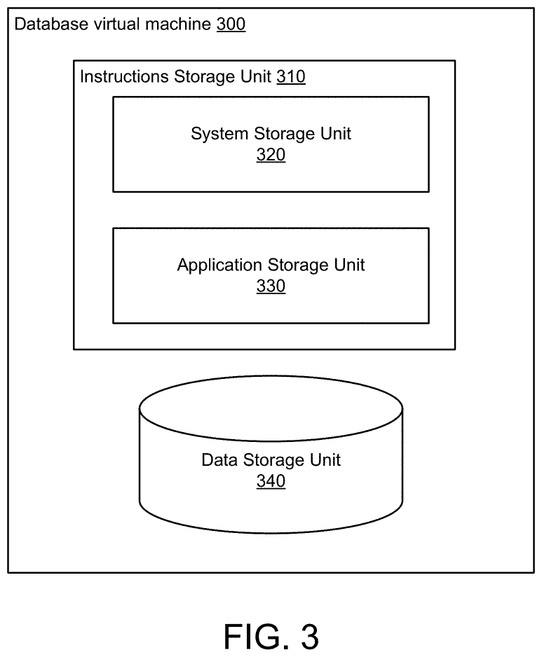

FIG. 3 is a block diagram illustrating architecture of a database virtual machine instance configured to run on a cloud platform, according to one embodiment. The database virtual machine 300 runs on a cloud platform and stores instructions and data of a database management system.

The database management system may store data on multiple databases that are stored in one site of different sites. A site may refer to a physical location in which computing resources are kept. For example, a site may be a data center comprising hardware including processors and storage devices. The database stores data and allows users to perform queries that may access data as well as modify the data. For example, the database may store records comprising fields and a query may insert new records, update existing records, and delete records. A query may request fields of records. The database is typically replicated. For a multi-tenant system, the database may store data for multiple enterprises, each enterprise representing a tenant of the multi-tenant system.

In an embodiment, the database management system processes user queries to process data stored in database. In an embodiment, the database management system processes queries in a particular query language, for example, structured query language (SQL). A query may be used to perform an action using the database, for example, update a record, add new record, or delete a record. The query may be used to access information, for example, values stored in one or more records.

The cloud platform stores data and instructions in storage units. A system using the cloud platform requests specific storage units and use them for specific purposes. Examples of storage units of cloud platform include elastic block store (EBS), or a logical unit number (LUN), or any other unit representing a portion of one or more storage devices that is allocated for a specific usage. A storage unit may also be referred to herein as a disk.

The database virtual machine 300 is configured so that the storage of the database management system is allocated into two distinct sets of storage units. The instructions of the database management system are stored in an instructions storage unit 310 and the data stored and processed by the database management system is stored in data storage unit 340. In an embodiment, the instructions storage unit further comprises a system storage unit 320 and an application storage unit 330.

The application storage unit 330 stores application level instructions of the database management system. The system storage unit 320 stores system level instructions that are low level instructions and are part of an operating system. For example, the system storage unit 320 stores system level instructions of the operating system related to booting and running the server (for example, the host of the virtual machine), data access operations, caching operations, input/output operations and so on.

The application level instructions may invoke the system level instructions. The application level instructions implement the functionality of the database management system including the query processing, database commands, and so on. The application level instructions also include configuration parameters for setting up the database management system. Typically, application level code is developed by developers that work on various aspects of a database management system for implementing features of the database management system.

The application level instructions further include schema templates for applying to the database. The schema templates create or update database predefined database objects that may be used for specific purposes. For example, the application level instructions include a multi-tenant schema that creates tables and other database structures for maintaining a multi-tenant system.

In an embodiment, the system prevents sharing of data across instructions storage unit and data storage unit. The tracks all the systems, applications, and data storage units attached to the virtual machine to ensure that each storage unit is used for the intended purpose. For example, the system checks to ensure that no user data of the database is stored in the instructions storage unit 310 and no instructions of the database management system are stored in the data storage unit 340. The system may be the online system 120 or the cloud platform 130. In an embodiment, the system receives instructions to allocate data files of the database and executable files of the database management system on various storage units. The system checks if there is any overlap in the storage units used for storing executable files and the storage units used for storing data files. If the system detects an overlap in the storage units used for storing executable files and the storage units used for storing data files, the system returns an error and fails the command used for allocating the storage. If the system detects no overlap in the storage units used for storing executable files and the storage units used for storing data files, the system successfully executes the command used for allocating the storage.

The instructions storage units are immutable whereas the data storage units are mutable or persistent and can be tracked. Accordingly, if the database virtual machine instance is updated, the instructions storage unit including the system storage unit and the application storage unit is erased and replaced with a new version of software whereas the data storage unit is left as it is through the upgrade process. In an embodiment, the data storage unit is detached from the instructions storage unit of the older version of the database management system and reattached to a new instructions storage unit storing the new version of the database management system to which the virtual machine is being upgraded. In some embodiments, the data storage unit is cloned to generate a replica of the data and the replica is attached to the instructions storage unit storing the new version of the database management software.

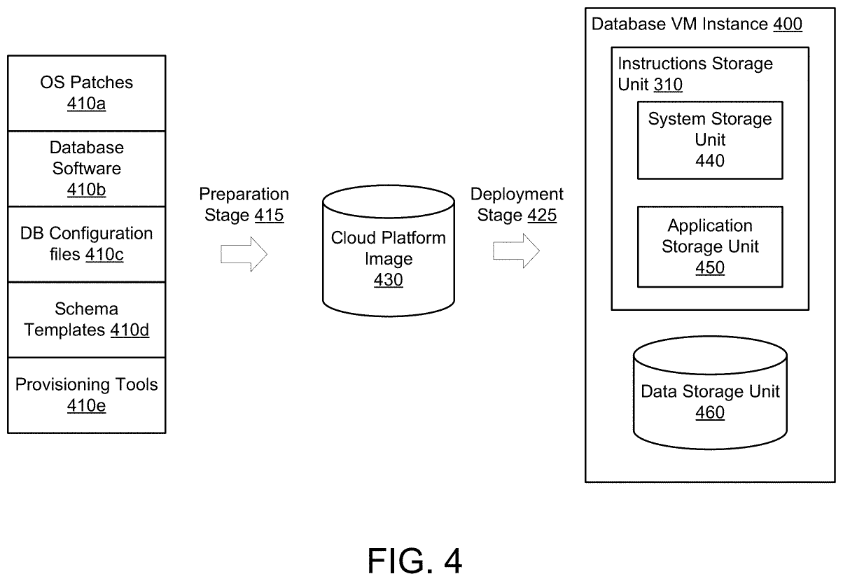

FIG. 4 is a block diagram illustrating stages of deployment of a database virtual machine instance on a cloud platform, according to an embodiment. The deployment of a database virtual machine instance comprises two stages, a preparation stage 415 and a deployment stage 425. In the preparation stage, the system creates a cloud platform image 430 including various components 410 such as: (1) the latest operating system (OS) patches 410a; (2) the database software 410b; (3) the latest database configuration settings files 410c; (4) the latest database schema template files 410d; and (5) the provisioning tools 410e representing instructions that are executed during the provisioning of the database virtual machine instance.

In the deployment stage 425, the cloud platform receives the cloud platform image 430 created in the preparation stage 415 and deploys a database virtual machine instance 400 configured to run the database management system. The cloud platform mounts the data storage unit 460 if available to the database virtual machine instance 400. The database management system may not be associated with a previous data storage unit, for example, if this is the first time the database management system is being installed by an organization and there is no previously stored data in the databases managed by the database managed system. If the database management system is not associated with a previous data storage unit, the cloud platform creates a new (empty) data storage unit 460 and mounts it on the database virtual machine instance 400. The cloud platform attaches the data storage unit 460 to the instructions storage unit 435 in the database virtual machine instance 400.

The cloud platform executes the provisioning tools 410e to perform various actions such as configuring the target database profile and configuration and applying the latest schema templates 410d by ensuring that the database schema conforms to the latest schema templates. The OS patches 410a are stored in the system storage unit 440 of the instructions storage unit 310 and the remaining components 410b, 410c, 410d, and 410e and stored in the application storage unit 450 of the instructions storage unit 310. Once the database VM instance 400 is configured, the cloud platform starts up the database management system and makes the running database management system available to users of the online system 120, for example, to tenants of a multi-tenant system. Systems and method describing upgrades of database management systems deployed in a cloud platform are described in U.S. patent application Ser. No. 17/320,960 filed on May 14, 2021, which is hereby incorporated by reference by its entirety.

### Replicated Database Management System Architecture

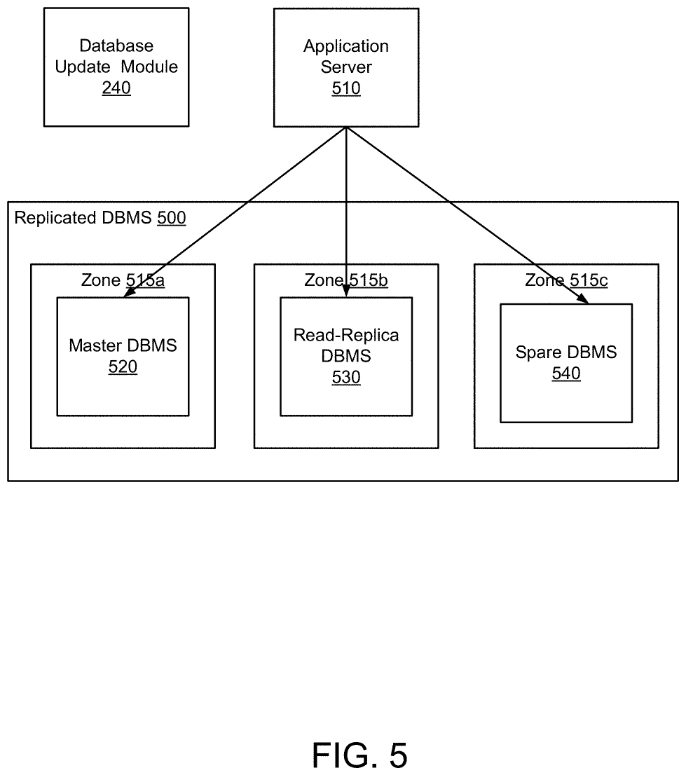

FIG. 5 is an architecture of a replicated database management system, according to one embodiment. The replicated database management system 500 includes a set of database management systems also referred to as nodes. The set of nodes of the replicated database management system 500 includes (1) a master node 520, (2) a read-replica node 530, and (3) a spare node 540. Each node is physically located in a zone 515. The various zones 515a, 515b, and 515c are physically separated by at least a threshold distance so that a disaster in a particular zone that may cause failure of a particular node does not affect the remaining nodes of the replicated DBMS.

The master node 520 receives and processes a subset of read requests and all write requests processed by the replicated database management system 500. All write requests from the application server 510 are directed to and processed by the master node 520. The read-replica node receives and processes only read requests. Accordingly, the replicated DBMS directs a subset of read requests to the read-replica node and the remaining read requests as well as all write requests are directed to the master node.

The spare node is used for high-availability purposes and in one embodiment does not receive any requests if the other nodes that belong to the replicated DBMS are functioning properly. However, if a failure occurs in a node, the spare node may be configured to perform the tasks of the failed node. For example, if there is a failure in the master node, the spare node is used as the master node and if there is a failure in the read-replica node, the spare node is used as the read-replica node. Once the failed node is fixed and is functioning normally, the roles of the nodes may be reversed.

As an example, assume that D1 is master node, D2 is read-replica node and D3 is the spare node. If there is a failure in D1, the node D3 is configured to work as the master node while D1 is being fixed. Once D1 is fixed, D1 takes the role of master node and D3 is reverted back to act as the spare node. If there is a failure in D2, the node D3 may be configured to work as the read-replica node while D2 is being fixed. Once D2 is fixed, D2 takes the role of read-replica node and D3 is reverted back to act as the spare node.

### Process of Upgrading a Replicated Database Management System

The system upgrades the replicated DBMS so as to preserve maximum availability of the database services to incoming traffic during the upgrade process. The system upgrades the individual nodes in a rolling fashion using real-time information to ensure maximum availability for end users or clients sending requests to the replicated DBMS. More specifically, the system upgrades the spare node first, followed by the read-replica node, which is followed by the master node.

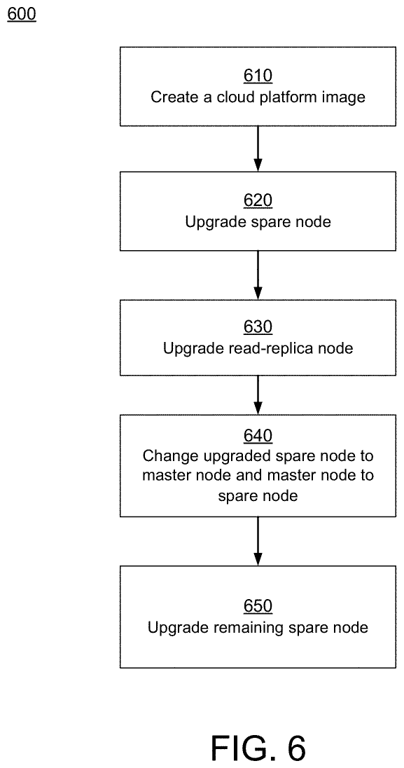

FIG. 6 is a flow chart illustrating the process for performing an upgrade of a replicated database management system, according to one embodiment. The steps indicated in the process may be performed in an order different from that indicated. Furthermore, the steps may be performed by modules different from those indicated herein.

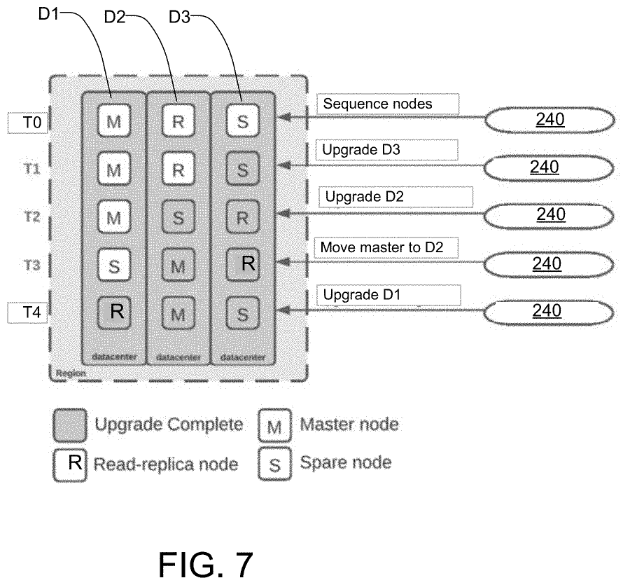

FIG. 7 is a block diagram illustrating the process for performing an upgrade of a replicated database management system, according to one embodiment. The steps described herein are executed by various modules of the online system but may be executed by other systems, for example, one or more computing systems of the cloud platform. The online system may also be referred to herein as the system. The steps of FIG. 6 are described in connection with FIG. 7. FIG. 7 shows the various steps being initiated by the database update module 240. However, any other module may initiate or execute the steps.

The system receives a request to upgrade a replicated DBM. This step corresponds to the time point T0 in FIG. 7. The replicated DBM includes (1) node (or database) D1 configured as a master node, (2) node D2 configured as a read-replica node, and (3) node D3 configured as a spare node. The replicated DBMS processes requests received from a set of application servers. The system is configured to direct write requests to the master node and distribute read requests across the master node and the read-replica node.

The system creates 610 a cloud platform image using the upgraded set of instructions for the database management system. The system sends instructions to upgrade 620 database D3 that is configured as the spare node. This configuration corresponds to time point Ti in FIG. 7 that shows node D3 as upgraded.

Subsequent to upgrading node D3 that is configured as the spare node, the system reconfigures the upgraded node D3 as read-replica node and node D2 as spare node. Accordingly, the system sends instructions to quiesce read requests to the database D2 configured as the read-replica node and configures database D2 as the spare node. This configuration is shown as time point T2 in FIG. 7. In this configuration all write requests are directed to the node D1 configured as the master node and read requests are distributed across the node D1 configured as the master node and the node D3 now configured as the read-replica node. Subsequent to configuring node D2 as spare node, the system sends instructions to upgrade the node D2.

After upgrading the node D2, the configuration is shown as time point T3. Accordingly, the system reconfigures the node D1 as spare node and node D3 as read-replica node. The system sends instructions to (1) quiesce read and write requests to the database D1 configured as the master node. Accordingly, all write requests are directed to database D2 configured as the master node and read requests are distributed across database D2 configured as the master node and the database D3 configured as the read-replica node. Subsequent to quiescing of read and write requests to the database D1, the system sends instructions to upgrade the database D1. This is the configuration shown at time point T4. At this point all three nodes are upgraded, and either D1 may be configured as a read-replica node and D3 as spare node or D3 may be configured as read-replica node and D1 as spare node. In alternate embodiments, since all three nodes are upgraded, any node may be configured to play any role depending on the amount of resource available to handle the types of requests processed.

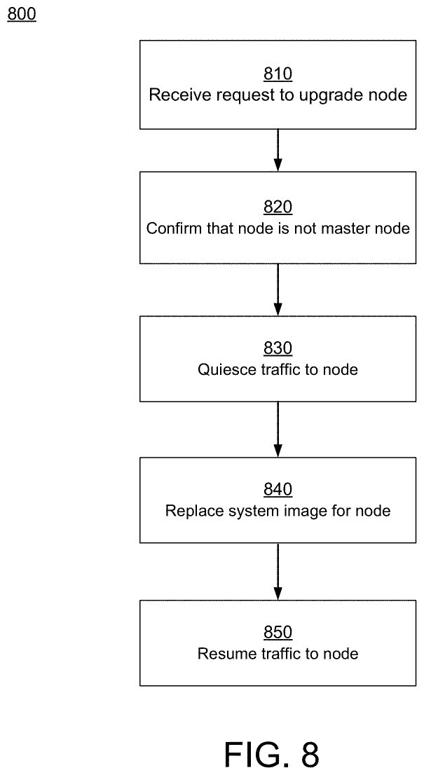

FIG. 8 is a flow chart illustrating the process 800 for upgrading a specific node in a replicated database management system, according to one embodiment. The system receives 810 a request to upgrade a node. The system confirms 820 that the node is not a master node. The system quiesces 830 the database traffic to that node. The system may quiesce 830 the database traffic to a node by sending requests to the application servers to quiesce requests directed to that node. The system waits for acknowledgement from each of the application servers to ensure that the application server quiesced the requests before proceeding to reconfigure the node or to upgrade the node.

The system replaces 840 the system image for that node to upgrade the database management system software for that node. The system shuts down the database management system running at the node to replace the image. The system may decouple the data storage unit of the node from the instructions storage unit before replacing the system image for that node with a system image comprising the upgraded instructions. The system reattaches the data storage unit to the instructions storage unit after replacing the system image for the node. The system resumes 850 traffic to that node after the system image is replaced.

### Computer Architecture

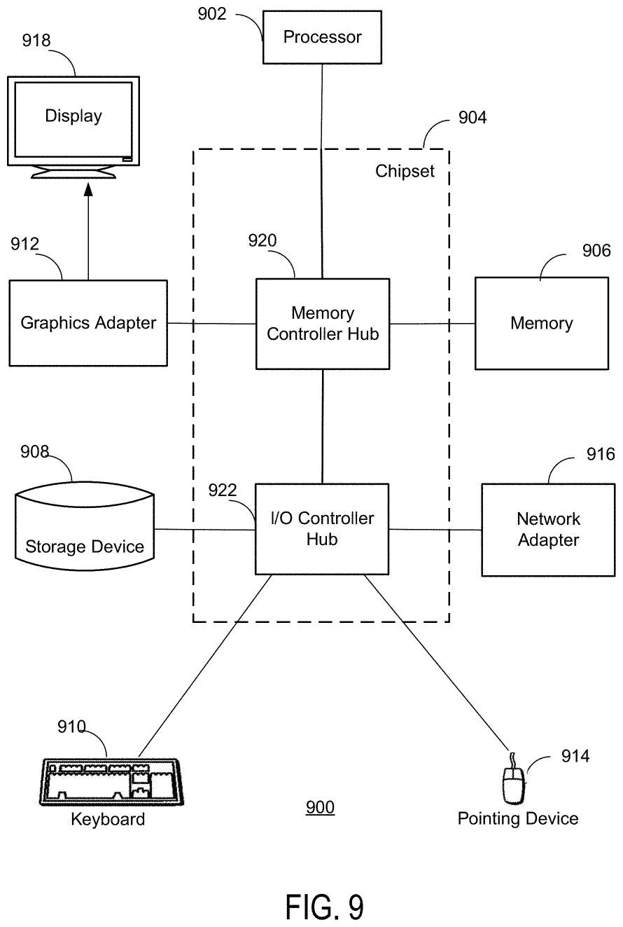

FIG. 9 is a high-level block diagram illustrating a functional view of a typical computer system for use as one of the entities illustrated in the environment 100 of FIG. 1 according to an embodiment. Illustrated are at least one processor 902 coupled to a chipset 904. Also coupled to the chipset 904 are a memory 906, a storage device 908, a keyboard 910, a graphics adapter 912, a pointing device 914, and a network adapter 916. A display 918 is coupled to the graphics adapter 912. In one embodiment, the functionality of the chipset 904 is provided by a memory controller hub 920 and an I/O controller hub 922. In another embodiment, the memory 906 is coupled directly to the processor 902 instead of the chipset 904.

The storage device 908 is a non-transitory computer-readable storage medium, such as a hard drive, compact disk read-only memory (CD-ROM), DVD, or a solid-state memory device. The memory 906 holds instructions and data used by the processor 902.

The pointing device 914 may be a mouse, track ball, or other type of pointing device, and is used in combination with the keyboard 910 to input data into the computer system. The graphics adapter 912 displays images and other information on the display 918. The network adapter 916 couples the computer system 900 to a network.

As is known in the art, a computer 900 can have different and/or other components than those shown in FIG. 9. In addition, the computer 900 can lack certain illustrated components. For example, a computer system 900 acting as an online system may lack a keyboard 910 and a pointing device 914. Moreover, the storage device 908 can be local and/or remote from the computer 900 (such as embodied within a storage area network (SAN)).

The computer 900 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 908, loaded into the memory 906, and executed by the processor 902.

The types of computer systems 900 used by the entities of FIG. 1 can vary depending upon the embodiment and the processing power used by the entity. For example, a client device may be a mobile phone with limited processing power, a small display 918, and may lack a pointing device 914. The online system 120 in contrast, may comprise multiple blade servers working together to provide the functionality described herein.

### Additional Considerations

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps and instructions described in the form of an algorithm. It should be noted that the process steps and instructions of the embodiments could be embodied in software, firmware or hardware, and when embodied in software, could be downloaded to reside on and be operated from different platforms used by real-time network operating systems.

The embodiments described also relate to apparatuses for performing the operations herein. An apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present embodiments are not described with reference to any particular programming language. It is appreciated that a variety of programming languages may be used to implement the teachings of the embodiments as described herein.

The embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the embodiments is intended to be illustrative, but not limiting.

We claim:

1. A computer implemented method for upgrading database management systems, the method comprising:
receiving a request to upgrade a replicated database management system comprising: a first node configured as a master node, a second node configured as a read-replica node, and a third node configured as a spare node, wherein the master node processes write requests received by the replicated database management system and read requests are distributed across the master node and the read-replica node;
upgrading the third node configured as the spare node;
subsequent to upgrading the third node, configuring the third node as the read-replica node and the second node as the spare node;
subsequent to configuring the second node as the spare node, upgrading the second node;
subsequent to upgrading the second node, configuring the first node as the spare node and one of the second node or the third node as the master node; and
subsequent to configuring the first node as the spare node, upgrading the first node.

2. The method of claim 1, wherein configuring the third node as the read-replica node and the second node as the spare node, comprises:
quiescing read requests directed to the second node; and
distributing read requests across the first node and the third node.

3. The method of claim 1, wherein configuring the first node to be the spare node and one of the second node or the third node to be the master node, comprises:
quiescing read and write requests directed to the first node; and
subsequent to quiescing the read and write request directed to the first node, directing write requests to the master node and distributing read requests across second and the third node.

4. The method of claim 1, wherein the read and write requests are received from a set of application servers, wherein quiescing requests directed to a node comprises:
sending a request to each of the application servers to quiesce requests; and
waiting for each of the set of application servers to send an acknowledgement message indicating a completion of quiescing of requests.

5. The method of claim 1, wherein the nodes of the replicated database management system are distributed across three data centers wherein the three data centers are situated in different physical locations.

6. The method of claim 1, wherein the spare node is used in case of failure of one of the master node or the read-replica node.

7. The method of claim 1, wherein the upgrade of a node comprises one or more of: installing a patch or upgrading to a new version of a software for the database management system.

8. The method of claim 1, wherein the replicated database management system is deployed on a cloud platform, the method further comprising:
receiving a cloud platform image for a new version of a software for the database management system, wherein the cloud platform image is used for upgrading any node.

9. The method of claim 8, wherein a database management system is stored using:
an instructions storage unit storing instructions of the database management system for processing data of a database; and
a data storage unit storing data of the database, wherein upgrading the database management system comprises installing new version of software for the database management system on a new instructions storage unit and providing the new instructions storage unit with access to the data storage unit.

10. A non-transitory computer readable storage medium for storing instructions that when executed by a computer processor cause the computer processor to perform steps comprising:
receiving a request to upgrade a replicated database management system comprising: a first node configured as a master node, a second node configured as a read-replica node, and a third node configured as a spare node, wherein the master node processes write requests received by the replicated database management system and read requests are distributed across the master node and the read-replica node;
upgrading the third node configured as the spare node;
subsequent to upgrading the third node, configuring the third node as the read-replica node and the second node as the spare node;
subsequent to configuring the second node as the spare node, upgrading the second node;
subsequent to upgrading the second node, configuring the first node as the spare node and one of the second node or the third node as the master node; and
subsequent to configuring the first node as the spare node, upgrading the first node.

11. The non-transitory computer readable storage medium of claim 10, wherein configuring the third node as the read-replica node and the second node as the spare node, comprises:
quiescing read requests directed to the second node; and
distributing read requests across the first node and the third node.

12. The non-transitory computer readable storage medium of claim 10, wherein configuring the first node to be the spare node and one of the second node or the third node to be the master node comprises:
quiescing read and write requests directed to the first node; and
subsequent to quiescing the read and write request directed to the first node, directing write requests to the master node and distributing read requests across second and the third node.

13. The non-transitory computer readable storage medium of claim 10, wherein the read and write requests are received from a set of application servers, wherein quiescing requests directed to a node comprises:
sending a request to each of the application servers to quiesce requests; and
waiting for each of the set of application servers to send an acknowledgement message indicating a completion of quiescing of requests.

14. The non-transitory computer readable storage medium of claim 10, wherein the nodes of the replicated database management system are distributed across three data centers wherein the three data centers are situated in different physical locations.

15. The non-transitory computer readable storage medium of claim 10, wherein the replicated database management system is deployed on a cloud platform, the instructions further causing the computer processor to perform steps comprising:
receiving a cloud platform image for a new version of a software for the database management system, wherein the cloud platform image is used for upgrading any node.

16. The non-transitory computer readable storage medium of claim 15, wherein a database management system is stored using:
an instructions storage unit storing instructions of the database management system for processing data of a database; and
a data storage unit storing data of the database, wherein upgrading the database management system comprises installing new version of software for the database management system on a new instructions storage unit and providing the new instructions storage unit with access to the data storage unit.

17. A computer system comprising:
a computer processor; and
a non-transitory computer readable storage medium for storing instructions that when executed by the computer processor cause the computer processor to perform steps comprising:
receiving a request to upgrade a replicated database management system comprising: a first node configured as a master node, a second node configured as a read-replica node, and a third node configured as a spare node, wherein the master node processes write requests received by the replicated database management system and read requests are distributed across the master node and the read-replica node;
upgrading the third node configured as the spare node;
subsequent to upgrading the third node, configuring the third node as the read-replica node and the second node as the spare node;
subsequent to configuring the second node as the spare node, upgrading the second node;
subsequent to upgrading the second node, configuring the first node as the spare node and one of the second node or the third node as the master node; and
subsequent to configuring the first node as the spare node, upgrading the first node.

18. The computer system of claim 17, wherein configuring the third node as the read-replica node and the second node as the spare node, comprises:
quiescing read requests directed to the second node; and
distributing read requests across the first node and the third node.

19. The computer system of claim 17, wherein configuring the first node to be the spare node and one of the second node or the third node to be the master node comprises:
quiescing read and write requests directed to the first node;
directing write requests to the master node; and
distributing read requests across second and the third node.

20. The computer system of claim 17, wherein the read and write requests are received from a set of application servers, wherein quiescing requests directed to a node comprises:
sending a request to each of the application servers to quiesce requests; and
waiting for each of the set of application servers to send an acknowledgement message indicating a completion of quiescing of requests.
